(19) United States
(12) Patent Application Publication
(10) Pub. No.: US 2010/0238932 A1
(43) Pub. Date: Sep. 23, 2010

(54) METHOD AND APPARATUS FOR ENHANCED PACKET AGGREGATION

(75) Inventors: Avraham Kliger, Ramat Gan (IL); Philippe Klein, Jerusalem (IL); Yitshak Ohana, Givat Zeev (IL)

Correspondence Address: Weiss & Arons, LLP, 1540 Route 202, Suite 8, Pomona, NY, 10970, US

(73) Assignee: Broadcom Corporation, Irvine, CA (US)

(21) Appl. No.: 12/698,260

(22) Filed: Feb. 2, 2010

Related U.S. Application Data
(60) Provisional application No. 61/161,490, filed on Mar. 19, 2009.
(60) Provisional application No. 61/167,228, filed on Apr. 7, 2009.

(51) Int. Cl. H04L 12/56

(52) U.S. Cl. 370/392

(57) ABSTRACT

Systems and methods for reducing the latency and for increasing throughput for MoCA devices that are connected via a coax network are provided. One method according to the invention includes, in a network having a plurality of network modules, each of the plurality of network modules being connected to a coax backbone, communicating over the coax backbone between the plurality of network modules. The method further includes a requesting the use of aggregated messages. The method further includes aggregations of messages at the Ethernet packet layer and/or at the MAC layer. The resulting messages can be received while making more efficient use of the MoCA network.

This application claims priority from U.S. Provisional Patent Application No. 61/161,490, filed Mar. 19, 2009, entitled “Enhanced Packet Aggregation”, and U.S. Provisional Patent Application No. 61/167,228, filed Apr. 7, 2009, entitled “System and Method for Aggregation of Packets for Transmission over a Network of Communication Channels” which are hereby incorporated by reference in their entirety.

### FIELD OF THE INVENTION

The present invention relates generally to information networks and specifically to transmitting information such as media information over communication lines such as coaxial cable (hereinafter “coax”), thereby to form a communications network.

### BACKGROUND OF THE INVENTION

Home networking over coax is a known technology which has vast commercial potential.

Home network technologies having a packet aggregation functionality are generally known. The Multimedia over Coax Alliance (MoCA™), at its website, provides example(s) of a suitable specification for networking of digital video and entertainment through existing coaxial cable in the home which has been distributed to an open membership. Packet aggregation functionality is not provided.

Home networking over coax taps into the vast amounts of unused bandwidth available on the in-home coax. More than 70% of homes in the United States have coax already installed in the home infrastructure. Many have existing coax in one or more primary entertainment consumption locations such as family rooms, media rooms, master bedrooms and other locations. Home networking technology allows homeowners to utilize this infrastructure as a networking system and to deliver other entertainment and information programming with high Quality of Service (QoS).

The technology underlying home networking over coax provides high speed (in some MoCA specification a speed of 270 mbps), high QoS, and the innate security of a shielded, wired connection combined with state of the art packet-level encryption. Coax is designed for carrying high bandwidth video. Today, it is regularly used to securely deliver millions of dollars of pay per view and premium video content on a daily basis. Home networking over coax can also be used as a backbone for multiple wireless access points used to extend the reach of wireless network throughout a consumer's entire home.

Home networking over coax provides a consistent, high throughput, high quality connection through the existing coaxial cables to the places where the video devices currently reside in the home without affecting the existing analog or digital services present on the cable. Home networking over coax provides a primary link for digital entertainment, and may also act in concert with other wired and wireless networks to extend the entertainment experience throughout the home.

Currently, home networking over coax works with access technologies, such as Asynchronous Digital Subscriber Line (ADSL) and Very high bit rate Digital Subscriber Line (VDSL) services or Fiber to the Home (FTTH), that typically enter the home on a twisted pair or on an optical fiber, operating in a frequency band from a few hundred kilohertz to 8.5 MHz for ADSL and 12 Mhz for VDSL. As services reach the home via unknown Digital Subscriber Line (xDSL) or FTTH, they may be routed via home networking over coax technology and the in-home coax to the video devices. Cable functionalities, such as video, voice and Internet access, may be provided to homes, via coaxial cable, by cable operators, and use coaxial cables running within the homes to reach individual cable service consuming devices locating in various rooms within the home. Typically, home networking over coax type functionalities run in parallel with the cable functionalities, on different frequencies.

The coax infrastructure inside the house typically includes coaxial cables and splitters. Splitters used in homes typically have one input and two or more outputs and are designed to transfer signals from input to outputs in the forward direction, or from outputs to input in the backward direction and to isolate splitter outputs and prevent signals from flowing room/outlet to room/outlet. Isolation is useful in order to a) reduce interference from other devices and b) maximize power transfer from Point Of Entry (POE) to outlets for best TV reception.

The MoCA technology is specifically designed to go backwards through splitters (insertion) and go from splitter output to output (isolation). All outlets in a house can be reached from each other by a single “isolation jump” and a number of “insertion jumps”. Typically isolation jumps have an attenuation of 5 to 40 dB and each insertion jump attenuates approximately 3 dB. MoCA has a dynamic range in excess of 55 dB while supporting 200 Mbps throughput. Therefore MoCA can work effectively through a significant number of splitters.

MoCA is a managed network unlike some other home networking technologies. It is specifically designed to support streaming video without packet loss providing very high video quality between outlets.

Digital cable programming is delivered with threshold Packet Error Rate (PER) of below 1 packet lost per millions packets sent. The home network should preferably have similar or better performance so as not to degrade viewing.

The disclosures of any publications and patent documents mentioned in the specification, and of the publications and patent documents cited therein directly or indirectly, are hereby incorporated by reference.

### SUMMARY OF THE INVENTION

A system and/or method for aggregation of packets for transmission through a communications network, substantially as shown in and/or described in connection with at least one of the figures, as set forth more completely in the claims.

### BRIEF DESCRIPTION OF THE DRAWINGS

Preferred embodiments of the present invention are illustrated in the following drawings:

FIG. 1 is a simplified block diagram illustration of a home networking over coax system having a packet aggregation functionality and being constructed and operative in accordance with a preferred embodiment of the present invention.

FIG. 2 is an example of a method by which a network access coordinator may control the access of a set of nodes to a medium interconnecting them.

FIG. 3A is a graph of typical network throughput as a function of PHY rate, for a conventional un-aggregated packet.

FIG. 3B is a graph of typical network throughput as a function of PHY rate, for an aggregated frame of packets provided in accordance with a preferred embodiment of the present invention, showing improvement vis-a-vis the graph of FIG. 3A.

FIG. 4 is a prior art diagram of ISO type mode layers in a LAN network.

FIG. 5 is a prior art diagram of a conventional structure for an Ethernet packet.

FIG. 6 is a prior art diagram of a conventional structure for an aggregation frame comprising more than one Ethernet packets, constructed and operative in accordance with a preferred embodiment of the present invention.

FIG. 7 is a simplified diagram illustrating a preferred method by which the MAC layer of a node aggregates individual MAC service data units into a single frame, operative in accordance with a preferred embodiment of the present invention.

FIG. 8 is a simplified diagram of a frame aggregated in accordance with a preferred embodiment of the present invention.

FIG. 9 is a table of Frame Types and Sub Type Formats in accordance with a preferred embodiment of the present invention.

FIG. 10 is a table summarizing Ethernet Aggregate SDU format in accordance with a preferred embodiment of the present invention.

FIG. 11 is a table summarizing a format for an Asynchronous Aggregate Data Reservation Request Element in accordance with a preferred embodiment of the present invention.

FIG. 12 is a table summarizing a format for Aggregate Data Allocation in accordance with a preferred embodiment of the present invention.

FIG. 13 is a simplified diagram of an example of a packet aggregation process operative in accordance with a preferred embodiment of the present invention.

FIG. 14 shows an aggregated frame structure according to the invention.

FIG. 15 shows a Table depicting a structure of the MAC header according to the invention.

FIG. 16 shows a Table depicting a structure of the Aggregated Ethernet format according to the invention.

FIG. 17 shows an illustration of actual vs. nominal aggregation quantum size according to the invention.

FIG. 18 shows an flow chart of an Aggregated Frame build process according to the invention.

FIG. 19 shows a table illustrating an asynchronous aggregated data reservation request element format for use with systems and methods according to the invention.

FIG. 20 shows a table illustrating an aggregated data allocation unit format according to the invention.

FIG. 21 shows a schematic diagram of an illustrative single or multi-chip device that may be used in accordance with principles of the invention.

FIG. 22 is a simplified diagram of a frame that may be used in connection with aggregation in accordance with a preferred embodiment of the present invention.

FIG. 23 is a table showing an illustrative MSDU header format.

FIG. 24 shows an illustrative MPDU header format.

FIG. 25 is a simplified diagram of aggregation in accordance with a preferred embodiment of the present invention.

FIG. 26 shows a schematic diagram of fragmentation of a single aggregated MPDU fragmented into two MPDUs according to the invention.

FIG. 27 shows an illustrative MPDU aggregation format.

### DETAILED DESCRIPTION OF PREFERRED EMBODIMENTS

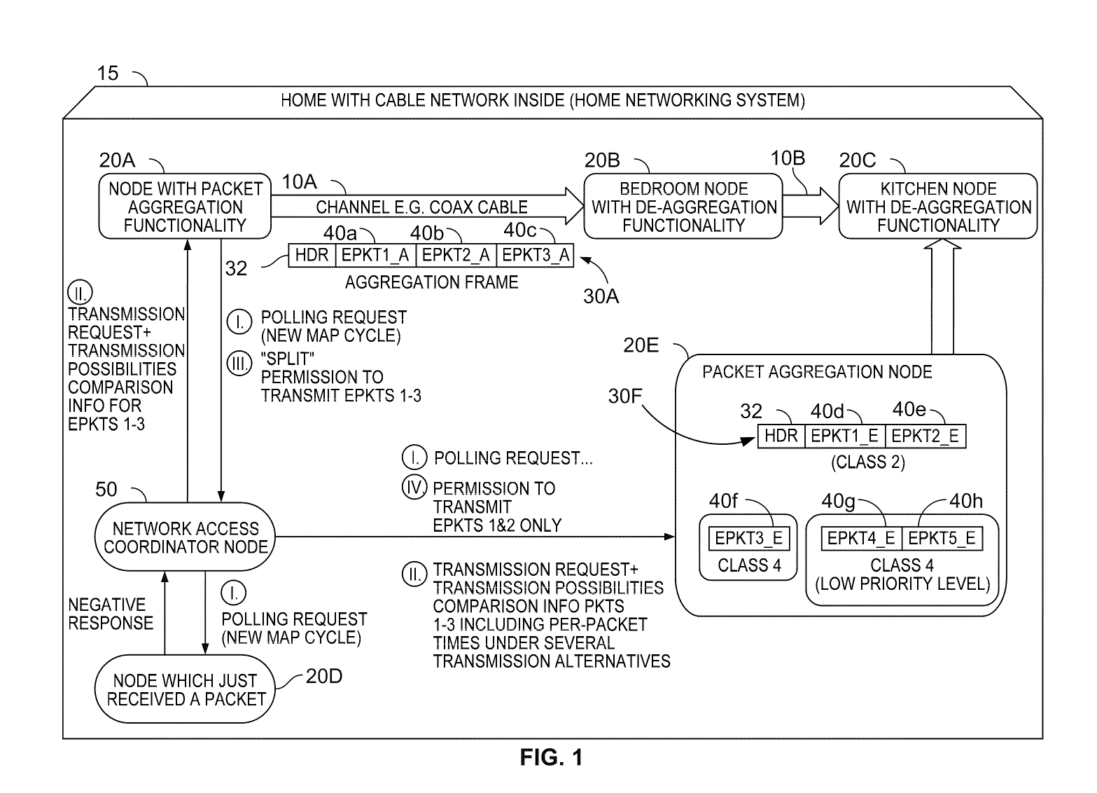

FIG. 1 is a block diagram illustration of an embodiment of a home networking over coax system having a packet aggregation functionality and being constructed and operative in accordance with a preferred embodiment of the present invention. The system of FIG. 1 is operative for transmitting packet(s) (such as the packets indicated in FIG. 1 by reference numerals 40a-40h which have accumulated at the node, (referred to collectively hereinafter as “packet(s) 40”) over a network of communication channels within a home 15 (such as, for example, the channels indicated in FIG. 1 by reference numerals 10A and 10B, referred to collectively hereinafter as “channels 10”). The channels may be wired channels e.g. cables such as coax cables or wireless channels or even channels on fiber optic cables. Also installed in the home 15 at endpoints of the channels 10 is a set of nodes 20 of which five nodes 20A-20E are shown by way of example. At least some of the nodes (nodes 20A-20E referred to collectively hereinafter as “nodes 20) have a packet aggregation functionality in which the node forms an aggregation frame (such as, for example, the aggregation frames indicated in FIG. 1 by reference numerals 30A and 30F, referred to collectively hereinafter as “aggregation frame(s) 30”) by aggregating a plurality of packets 40. If at least one packet 40 has accumulated at the node, each node is operative, to transmit a frame including that packet 40 and perhaps others, typically upon grant of solicited (as in the illustrated embodiment) or unsolicited permission to transmit.

Generally, as described in detail below, the system of FIG. 1 is useful in performing the following method for transmitting packets 40 over a network of communication channels 10 interconnecting a set of nodes 20. The method may include using a network access coordinator 50 to coordinate access of the set of nodes 20 to the network of channels 10 by granting permission to transmit to individual nodes 20. The method may further include forming an aggregation frame 30 at one or more node(s) 20 by aggregating a plurality of packets 40 which have accumulated at the node. The method may also include informing the network access coordinator node 50 about the nature of the aggregation frame 30, and providing the network access coordinator node 50 with comparison information comparing different transmission possibilities for the aggregation frame 30. If at least one packet 40 has accumulated at a node 20, the method may include transmitting at least one frame upon grant of permission to transmit to the node 20 by the network access coordinator 50. Each frame may comprise at least one packet 40. The network access coordinator 50 is typically operative to determine which portion, if any, of the aggregated frame 30 which may be transmitted. Such a determination may include determining an integral number of aggregated packets 40 to be transmitted from among several aggregated packets 40 which have accumulated at the relevant transmission node(s) 20.

Typically, each node comprises a modem having a CL (Convergence Layer), a MAC (Media Access Control) layer and a PHY (Physical) layer and the packet aggregation functionality is performed at the CL which may be at the ECL (Ethernet Convergence Layer) if the packets 40 are Ethernet packets. Ethernet packets are abbreviated “Epkts”).

Each aggregation frames 30 typically comprises at least some of the following information: an indication that the frame is an aggregation frame 30 rather than a single-packet frame and an indication of the size of at least some of the packets 40 in the aggregation frame 30. This information is typically stored in the header 32 of an aggregation frame 30. Each packet 40 in each aggregation frame 30 typically has a header having CRC (cyclic redundancy check) code for the header itself and CRC code for the content of the packet.

A network access coordinator 50, which may itself be a node 20, is operative to coordinate the access of the plurality of nodes 20 to the network of channels 10 by granting or refusing transmission requests or by granting unsolicited transmission permission. At least one of the nodes 20 is operative to inform the network access coordinator 50 when it has formed at least one aggregation frame 30 comprising at least one aggregated packet 40 and to provide the network access coordinator 50 with comparison information comparing different transmission possibilities for the aggregation frame. The network access coordinator 50 is operative to determine which portion, if any, of the aggregated packets 40 can be transmitted including determining an integral number of aggregated packets to be transmitted.

Typically, as shown, at least one node 20 is operative to send a transmission request and the network access coordinator 50, grants or refrains from granting permission to transmit. In FIG. 1, for example, node 20A requests permission to transmit three Ethernet packets (aggregated in frame 30A) to node 20B which is located in the bedroom. Permission is granted, albeit in two separate time slots (see steps I, II, and III (slot III which indicates that a split permission is granted)) whose combined length suffices to transmit the three packets 40a, 40b and 40c.

It should be noted that some embodiments of systems and methods according to the invention do not require polling. Rather systems and methods according to the invention may include such network processes that provide each node with a reservation request at some preferably pre-determined period without the requiring the node to request a reservation request.

Node 20E also requests permission to transmit three Ethernet packets 40 to node 20C which is located in the kitchen (as shown in slot IV). However, coordinator 50 grants permission to transmit only two of these packets 40g and 40h (as shown in slot V). Therefore, packet 40f remains at node 20E for the time being. Nodes 20B and 20C may each de-aggregate the frames 30A and 30E that they respectively receive as shown.

Requests for transmission permission are preferably accompanied by comparison information typically comprising a comparison of the per-packet times required given various different transmission possibilities as described in U.S. Provisional Patent Application No. 60/940998, filed May 31, 2007, entitled “MoCA Aggregation”, and U.S. patent application Ser. No. 11/924,214, filed Oct. 25, 2007, entitled “System and Method for Aggregation of Packets for Transmission Through a Communications Network” which are hereby incorporated by reference in their entirety.

Packets 40 may comprise packets of different classes and at least one node 20 may be operative to aggregate packets 40 which have accumulated at the node 20, which are sorted as a function of the class to which the packets 40 belong. For example, in FIG. 1, node 20B accumulated two Class 2 packets 40, two Class 4 packets 40 aggregated together, and another Class 4 packet 40 not aggregated with the other two. Class 4 is a class of low priority level packets 40 in the illustrated example. The Class 2 packets 40 may, for example, be characterized by having a common QoS, and/or a common priority level, and or common membership in a particular flow; and/or any other packet attribute or set of packet attributes. Aggregation “rules” observed by individual nodes may be dependent on class or on other parameters of the system. For example, individual nodes 20 may be operative to aggregate only packets 40 belonging to classes included in predefined classes and to refrain from aggregating packets belonging to classes other than those predefined classes.

Individual nodes 20 may be operative to aggregate all packets which have accumulated at the node 20 between each of the node's transmission requests. This optional aggregation “rule” may refer to any transmission request or may be specific to transmission requests pertaining to a particular type of node 20.

Optionally, an embodiment of system of FIG. 1 is polling-based. In polling-based systems, the network access coordinator 50 is operative to repeatedly poll the nodes 20 for transmission requests by sending polling requests thereto. The network access coordinator subsequently may grant at least some of the received transmission requests. The network access coordinator is typically operative to poll once per MAP cycle. Each node 20, having accumulated at least one packet, may be operative to respond positively to the first polling request which follows a predetermined time interval after receipt of the one or more packets, and may respond negatively if the predetermined time interval has yet to elapse (e.g. negatively responding node 20D in FIG. 1). Alternatively, each node 20, having accumulated at least one packet 40 in at least one individual class of packets 40, may substantially immediately respond positively, to the next polling request with respect to the at least one class of packets 40.

If the system of FIG. 1 is not polling-based, a different embodiment may allow at least one node 20 to send a transmission request periodically. Optionally, at least one such node 20 may be operative, in addition to sending a transmission request periodically; a node 20 may send a transmission request each time a set of packets 40 having predetermined characteristics has accumulated thereat. For example, some nodes 20 may send a transmission request even if the defined between-request time interval has not elapsed, or if more than n packets 40, e.g. six packets 40, have accumulated. Such an occurrence may reset the time for the between-request time interval. In another embodiment a transmission request for packets 40 in a particular class might be sent each time n packets 40 belonging to that particular class have accumulated at a node 20.

Optionally, at least one node 20 is operative to aggregate no more than a predetermined maximum number of packets 40 into each frame. For example, node 20E aggregates only up to two packets per frame or, perhaps, aggregates only up to two packets per frame if the packets are class 4 packets. Therefore, the third Class 4 packet 40f which accumulated at node 20E is not part of aggregation frame 30E.

The system of FIG. 1 may, for example, operate within or in conjunction with a Home Network modem in general and in particular a home network over coaxial cables such as, by way of example, the home network over coaxial cables as described in the above-referenced MoCA specification. In the MoCA specification, a coordinated home network is described in which a Network Coordinator (also termed herein a “network access coordinator”) exists and coordinates the access to the medium. Only one node is allowed to transmit at a time, creating a non collision network. This facilitates the ability to carry video as well as voice and data signals over the same network, while retaining the requirements of video and voice streaming and Quality of Service.

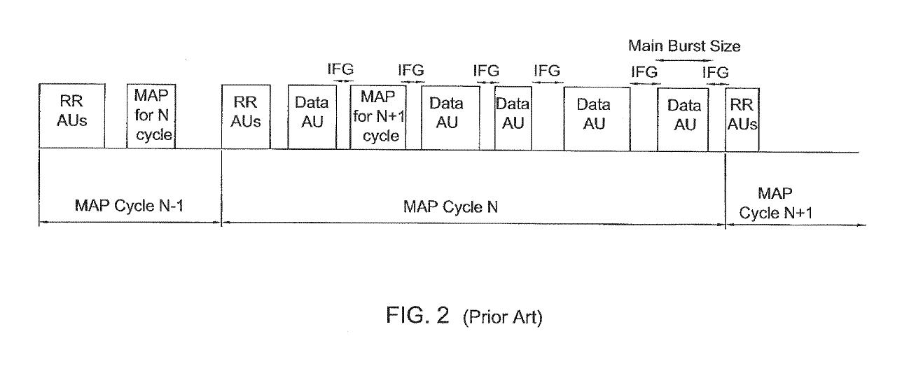

FIG. 2 shows an example of an access method in a typical MoCA system. Once in a MAP CYCLE, a node 20 that has several packets (e.g. Ethernet packets) in its buffer sends a Reservation Request (RR) message for each packet. The Network Coordinator (NC) may then allocate a time slot for each packet transmission as is shown in FIG. 2.

Typically, the transmission is comprised of bursts, each burst including a Preamble, a Header, the data Payload and an FCS (Frame Checker Sequence). Inter Frame Gaps between frame transmissions may be provided and a minimal Burst size may be specified. If a packet 40 is shorter than the minimal packet size a minimal packet size time slot may still allocated. All these exemplary requirements create overhead that reduce the effective throughput of the network.

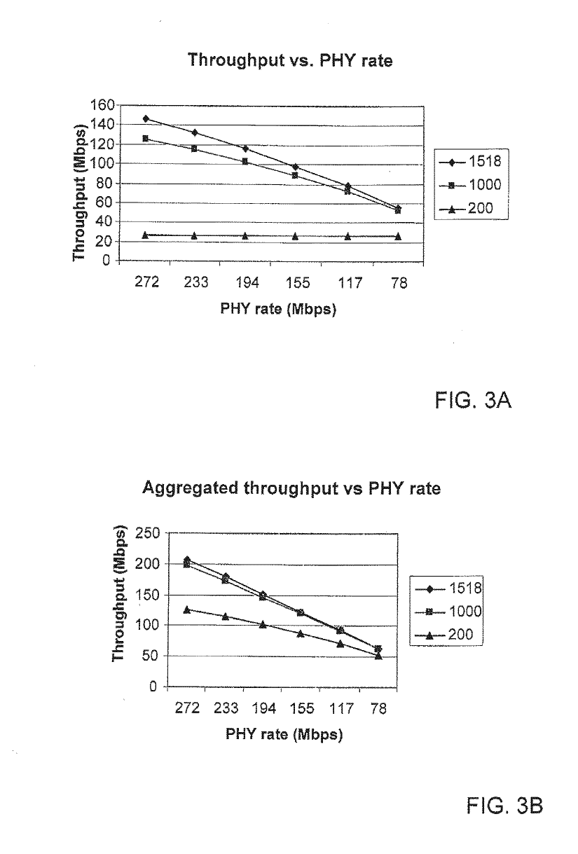

FIG. 3A shows throughput (the actual information rate sent over the network) vs. the PHY rate (the available data rate) for the following sizes of Ethernet packets: 1518 Bytes, 1000 Bytes and 200 Bytes. It is clear that the available throughput decreases significantly with the packet size or even smaller.

One method of increasing throughput is to aggregate several incoming packets (e.g. Ethernet packets) and to send all of them in a single time allocation and single transmission frame. FIG. 3B is a graph depicting effective throughput vs. PHY rate with five packet-aggregation, which demonstrates clear improvement of the effective throughput for the network.

Two alternative embodiments for packet aggregation according to the invention are now described. The first is ECL packet aggregation; the second is MAC Layer packet aggregation. The two embodiments may co-exist on a network. Nodes 20 that support these methods may also support the non-aggregated scheme as specified in the current MoCA Specification. This accommodation allows nodes 20 that support packet aggregation to be interoperable with legacy nodes that do not support aggregation.

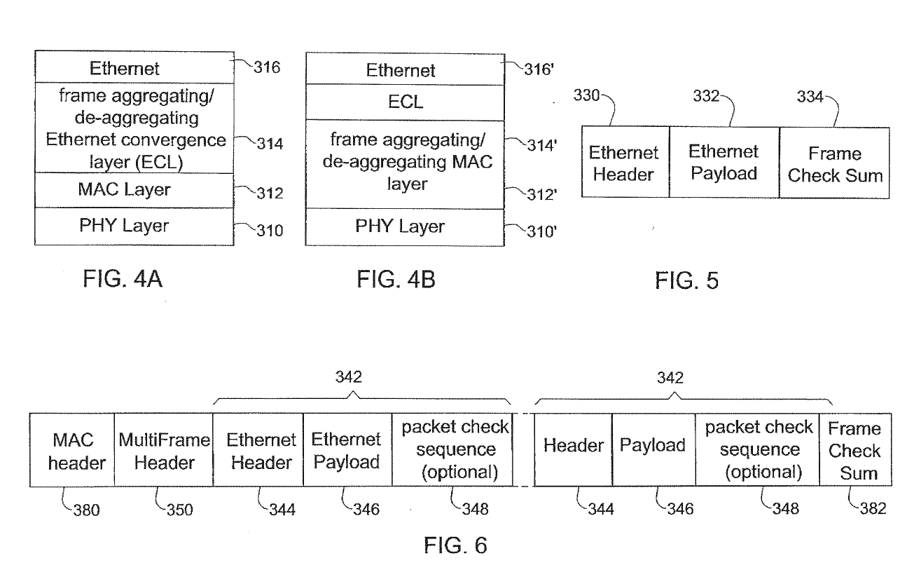

It is appreciated that the home network is comprised of (ISO mode) layers as shown in FIGS. 4A and 4B. These layers include Layers 1 and 2 (PHY 310 and MAC 312, as shown in FIG. 4A) and a aggregating/de-aggregating Ethernet Convergence Layer 314 that bridges between MAC layer 312 and Ethernet Layer 316. Alternatively, as shown in FIG. 4B, ECL 314′ can bridge between another Layer 2 protocol (like 1394, USB or Ethernet) and its own Layer 2 frame aggregating/de-aggregating MAC layer 312′. Also shown in FIG. 4B are PHY layer 310′ and Ethernet 316′. In the embodiment described herein, both the Ethernet and the Ethernet Convergence Layer (ECL) are considered.

A preferred method for Ethernet convergence layer packet aggregation is now described. One possible circumstance where this embodiment of packet aggregation may be useful is a situation in which Ethernet packets are arriving from an external source, such as a GMII or MII interface.¹ A conventional Ethernet packet structure 335 is depicted in FIG. 5 and comprises an Ethernet Header field 330, the payload field 332 and Frame Check Sequence (FCS) 334. Ethernet Header 330 includes data describing the source and destination addresses as well as information describing priorities and other information that may be used in the course of further processing of the Ethernet packet 335. Ethernet Payload 332 is the actual transmitted data and FCS 334 may be a result of CRC processing to detect packet errors. Media Independent Interface (MII) and Gigabit Media Independent Interface (GMII) are interfaces between the Media Access Control (MAC) device and the physical layer (PHY). GMII is preferably backwards compatible with MII.

According to one embodiment of the present invention, aggregation is implemented within the ECL. The ECL collects Ethernet packets 335 that have the same destination and the same priority in a queue.

Typically, when the node 20 is ready to transmit, the Ethernet packets 335 (shown in FIG. 5) may be transformed into aggregated Ethernet packets 342 which are themselves encapsulated into an ECL Frame structure 385 which comprises a MAC header 380, a multi-frame header 350, at least one aggregated Ethernet packet structure 342 and a frame check sum 382 as depicted in FIG. 6. Each aggregated Ethernet packet structure 342 comprises an Ethernet header 344, a payload 346, and an optional FCS 348, MAC Header 380, MultiFrame Header 350, payload 332, FCS 334 and Frame Checksum 382 may contain at least the following information: source address, destination address, priority, number of encapsulated frames, byte lengths of the individual frames and, optionally, a checksum.

Typically, Ethernet headers 344 of the aggregated Ethernet packets 342 are encapsulated together with payload 346, FCS 348 may also be encapsulated; but is typically not required to detect errors in the aggregated Ethernet packet 342 at the receiver. The aggregated ECL packet 342 has a structure similar to a single Ethernet packet 335 (shown in FIG. 5) but is larger in size. It is delivered to the MAC Layer who handles it as a regular Ethernet packet 335. The size of the a single aggregated ECL packet 342 can be as high as 64 Kilobytes (KB), however, a size of five Ethernet packets (about 8 KB) are large enough to gain the enhancement achievable through packet aggregation. Preferably, at the receiving side, the MAC transfers the received ECL frame 385 back to the ECL Layer, where the multi-frame checksum 382 is checked, and the multi-frame header 350 is processed to de-aggregate the embedded Ethernet packets.

The Reservation Request and grant are typically handled by the MAC in the same way as it handles non-aggregated packets. The MAC simply regards the aggregated packet as a single MAC Service Data Unit (MSDU).

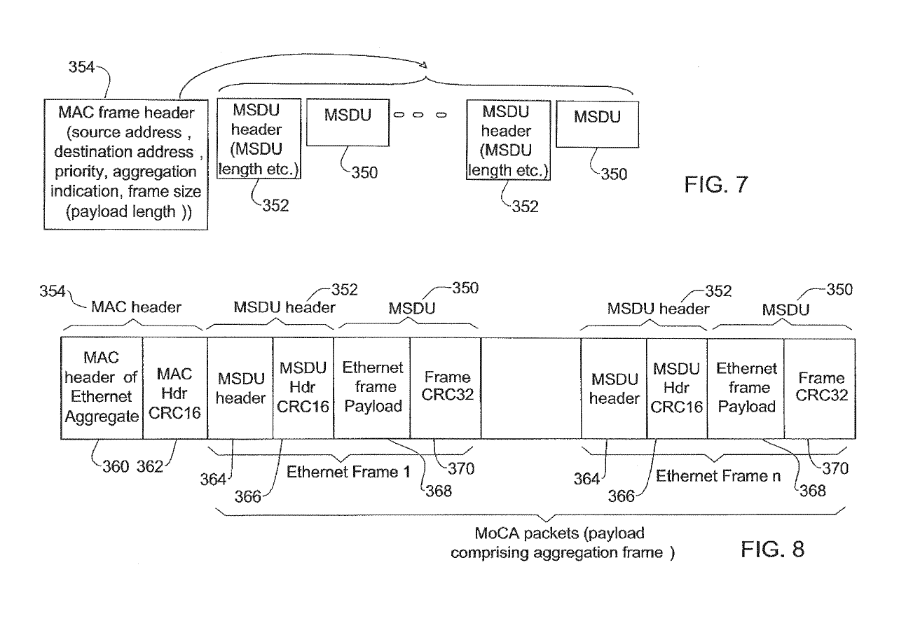

The second exemplary aggregation method according to the invention, MAC layer packet aggregation, is now described. Typically, the MAC layer aggregation method is agnostic to the upper Layer 2 protocol and therefore is not restricted to Ethernet frames but can be used for other protocols. The MAC receives one or more individual MSDU 350 from the upper layer and may aggregate them, e.g., as shown in FIG. 7. The MSDU(s) 350 may be comprised of a Ethernet packet(s) but may also be of other type of packet(s).

Typically, the MAC frame header 354 (which includes a source address, destination address, priority, aggregation indication, frame size (payload length)) appends a MSDU header 352 to the MAC frame 353 for each individual MSDU 350 and a CRC (not shown in FIG. 7) to each individual MSDU 350 to create a MAC multi-frame with a multiplicity of MAC MSDUs 350.

FIG. 8 shows an aggregation frame 395 according to the second aggregation method. In each aggregation frame there is a MAC header 354 which may include a MAC header may be comprised of Ethernet Aggregate 360 and/or a MAC Hdr CRC16 362 and one more Ethernet frames 390. Each Ethernet frame 390 is comprised of a MSDU header 352 and a MSDU 350. A MSDU header 352 may be comprised of MSDU header 364, MSDU Hdr CRC 16 366. A MSDU 350 comprises Ethernet frame Payload 368 and Frame CRC32 370. The structure of the aggregation frame 395 enables receipt of individual MSDUs 350 at the receiver. If an error occurs while receiving one of the MSDUs 350, the other MSDUs 350 can still be received correctly. Aggregation is performed per destination node ID and source node ID and priority. The information contained in the MAC Frame header 354 is similar to that contained in the ECL frame 385. At the receiver the MAC layer de-aggregates the MAC multi-frame 395 into individual packets.

In accordance with the second aggregation method, reservation requests and grants are handled by the MAC using, for example, one of the following methods:

One embodiment for managing reservation request begins with the requesting node sending a single request for the entire aggregated frame. The Coordinator may respond by granting (or not granting) permission to transmit the whole MAC frame as a single MSDU.

Another embodiment begins with the requesting node sending a reservation request for a single MSDU or for several of the MSDUs in an aggregated frame, handling the aggregated frame the same way as the requesting node handles individual MSDUs. The Coordinator may be responsible for “deciding” on the possibility aggregation as well as on the number of MSDUs to be aggregated, and sends a grant appropriately. A particular advantage of this method is centralizing greater control and flexibility with the network coordinator.

In an exemplary hybrid MoCA network, if the network coordinator supports packet aggregation it is possible to send aggregated packets between any two nodes that support aggregation as described herein. Preferred methods for requesting, granting and sending an aggregated frame are now described.

An exemplary packet, such as a MoCA packet, may be aggregated with multiple Ethernet frames having the same priority level and same destination node. A MoCA control packet typically cannot be aggregated. There may be a maximum number of Ethernet frames that can be aggregated in a single MoCA packet.

Typically, each MoCA node that wants to send a MoCA packet with multiple Ethernet packet requests, from the network coordinator, a duration which would be required for each Ethernet packet to be sent in its own MoCA packet. The MoCA node may further indicate the time that will be saved if the multiple Ethernet packets were sent in a single aggregated packet. The network coordinator may grant a slot for sending all aggregated Ethernet frames which have accumulated as a single packet or may split the Ethernet frames into two or more MoCA packets. In accordance with the MAP received from the network coordinator, the node sends its Ethernet packets, in one burst or in multiple bursts. The time saved when sending multiple Ethernet packet in one packet is typically limited to the time related to the transmitting of the preamble overhead and may not include the FEC (Fast Ethernet Channel (a method for bundling Ethernet channels)) or OFDM (Orthogonal Frequency Domain Multiplexing) modulation padding.

It is appreciated that for simplicity, the present specification assumes that a node typically responds to polling requests, either positively or negatively. A positive response occurs when the node reports accumulation of packets and requests permission to transmit in response to the polling signal from the network access coordinator. A negative response occurs when the node receives a polling request but refrains from requesting permission to transmit. It is appreciated that a single response may be positive with respect to certain classes of packets and negative with respect to other classes of packets e.g., the node may request permission to transmit packets which have accumulated from flow A and may refrain from requesting permission to transmit packets which have accumulated from flow B.

It is also appreciated that packets are sometimes divided into or partitioned into different classes. They may be aggregated regardless of class or with regard to class. A class may comprise a level of priority and/or at least one of a common source and destination addresses.

Some embodiments of the invention relate to aggregation that is compatible with existing industry standards. In order to interoperate with the existing and proposed MoCA standards, and to make the aggregation efficient, an embodiment according to the invention where aggregation is requested by a node and is granted by the network access coordinator (NAC) is described using the existing Reservation Request (RR) and grant mechanism. In this scheme, the NAC is capable of granting all or part of the aggregation request. The node may request another transmission opportunity for the packets, which cannot be sent with the currently received grant of permission, on the next Media Access Plan (MAP) cycle.

Some benefits associated with this scheme include but are not limited to the following benefits: Aggregation can be performed at the MAC (Media Access Control) layer, whereby each Ethernet packet may be protected by its own CRC, built-in fragmented-ready aggregation is obtained, aggregation may be structured by the NAC 50 to provide better bandwidth utilization, an alternative mode according to another embodiment of the invention allows a simple packet aggregation protocol and a robust frame structure, whereby the scheme may be scalable with aggregated frame size and the number of aggregated packets.

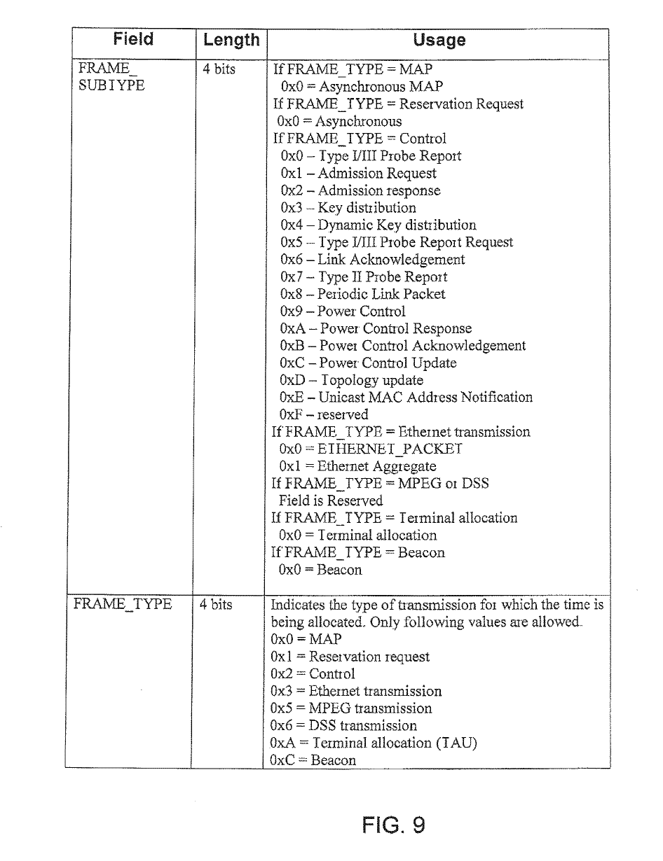

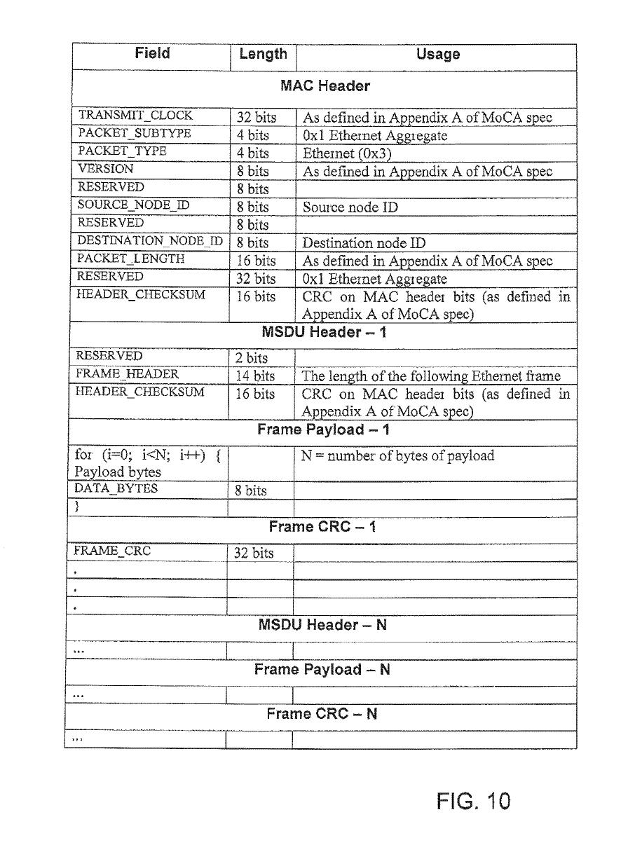

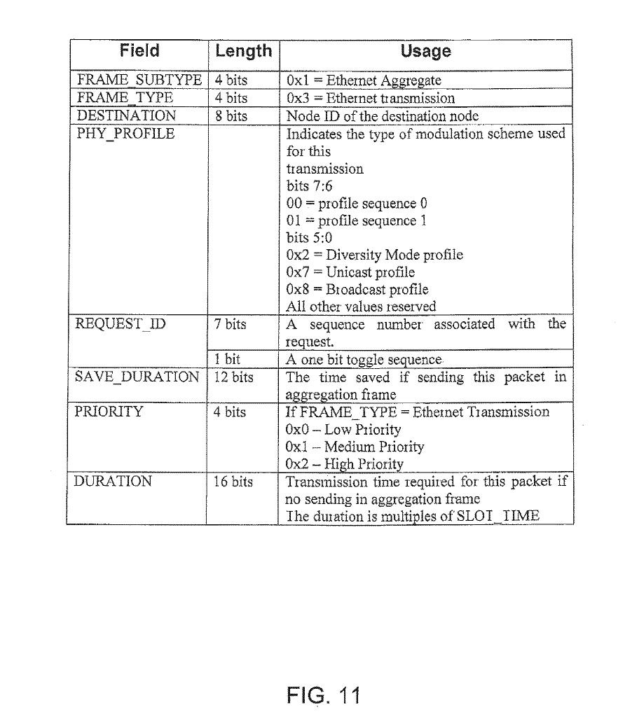

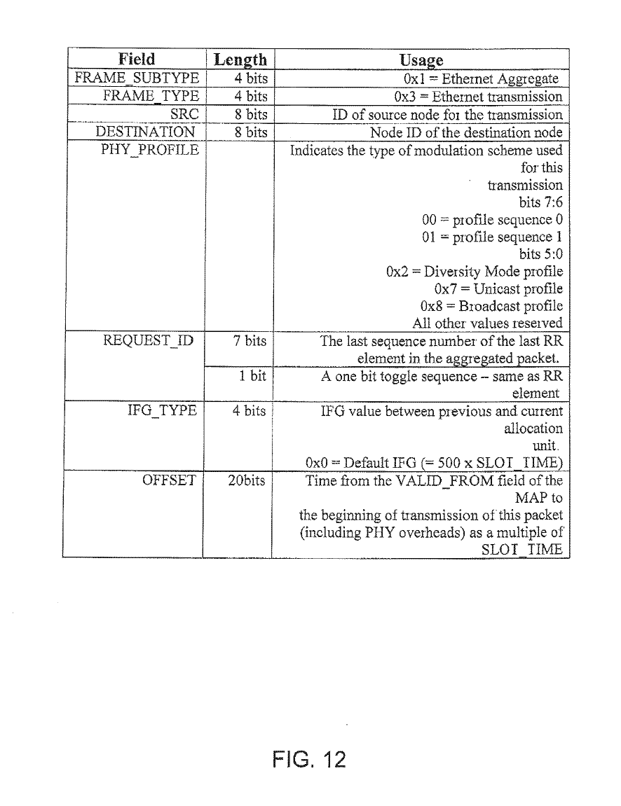

A media-over-coax protocol is now described with reference to FIGS. 9-12. FIG. 9 is a table of Frame Types and Sub Type Formats in accordance with an embodiment of the present invention. FIG. 10 is a table summarizing an Ethernet Aggregate SDU format in accordance with an embodiment of the present invention. FIG. 11 is a table summarizing a format for an Asynchronous Aggregate Data Reservation Request Element in accordance with an embodiment of the present invention. FIG. 12 is a table summarizing a format for Aggregate Data Allocation in accordance with one embodiment of the present invention.

Typically, in one embodiment, for each Ethernet packet the node computes the transmit duration including the overhead duration (e.g., preamble, FEC (Forward Error Correction) and symbol padding). The duration value is placed in the DURATION field in the reservation request element. The value of the SAVE_DURATION field is the duration of the preamble. In the reservation request for the transmission of a single Ethernet packet the save time is typically set to zero. All Ethernet packets which, as per the reservation request, are to be sent in aggregation frame may be marked with the same value of the toggle bit in the REQUEST_ID field. The consecutive same value in the toggle bit associates the RR (reservation request) with the single MoCA packet. All reservation requests to be sent for a single MoCA packet are typically arranged one after the other, without other reservation request elements in between.

Typically, in one embodiment of the invention, the n network access coordinator accesses the MAP constraints and, in accordance therewith may allocate a slot for an aggregate packet. If one packet is allocated for all Ethernet packets, the network coordinator supplements all durations in the reservation request related to the same MoCA packet and subtracts all saved durations. The result is the burst time of the aggregated packet. If the network coordinator allocates multiple packets to the Ethernet frames, the saved duration of the first Ethernet frame in the MoCA packet may not take into account the burst time computation. The Request ID typically placed in the Allocation Unit (AU) of the last sequence ID of the Ethernet frame in the MoCA aggregated packet.

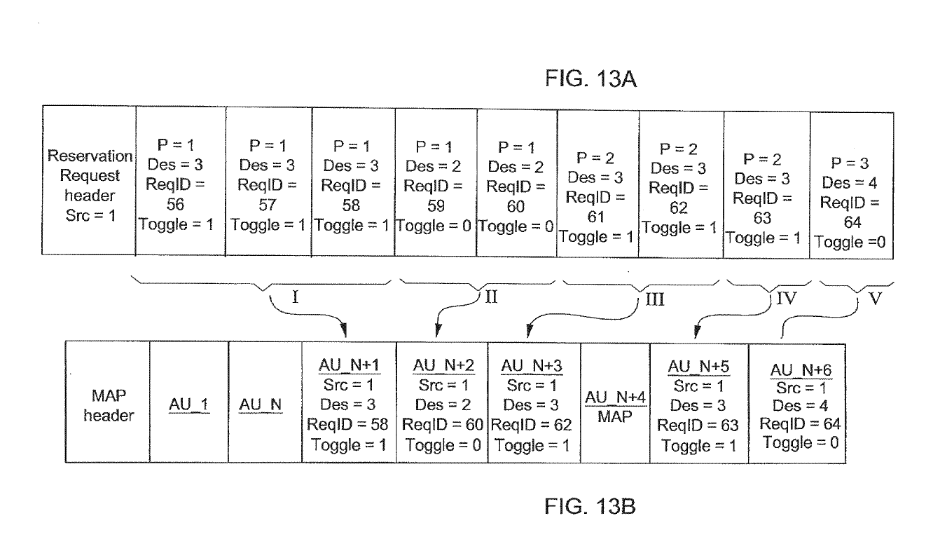

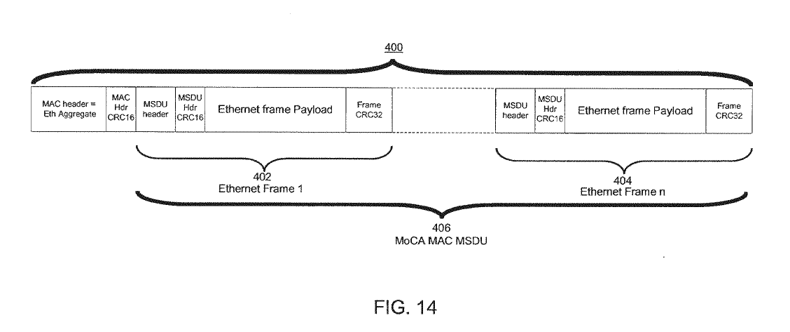

FIGS. 13A and 13B are an example of a packet aggregation process provided in accordance with another embodiment of the present invention. As shown by Roman numerals I, II, and III in FIG. 13 multiple packets can be aggregated into single units, as shown in FIG. 13B. FIG. 14 shows a preferred embodiment of an aggregated frame structure 400 according to the invention. Structure 400 includes multiple Ethernet packets, such as into those converted to Ethernet frame(s) 1 402 and frame n 404. Frames 402 and 404 may share a common Ethernet Destination Address and the same priority level (tagging) or QoS flow, and may be aggregated into a single MoCA MAC Aggregated Frame (AF). In one embodiment of the invention, MoCA control packets may not be aggregated. Nevertheless, other embodiments of the invention may contemplate situations where the MoCA control packets may be aggregated.

In one embodiment of the invention, Ethernet frame(s) such as frames 402 and 404, can be aggregated until one the following conditions occur: the node is scheduled to transmit a Reservation Request (RR) or either the size threshold or the maximum latency threshold for the aggregated frame has been reached.

The aggregated MAC frame 400 in FIG. 14 may include a MAC header having the same structure of at least one type of MoCA MAC Header and a sequence of MAC Service Data Units (MSDUs) 406 comprising of a Header, the MSDU payload and an FCS (Frame Check Sequence) based on a CRC (Cyclic Redundancy Check).

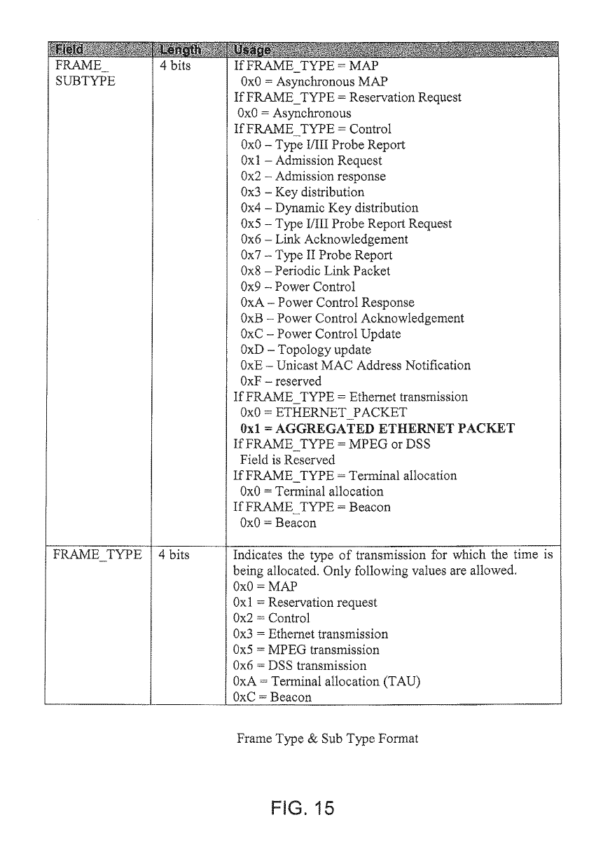

The structure of the MAC Header is depicted in the Table shown in FIG. 15. As shown in FIG. 15, a new FRAME_SUBTYPE is added to the Ethernet Transmission Frame Type to indicate an Aggregated Ethernet packet in the form of an Ethernet frame.

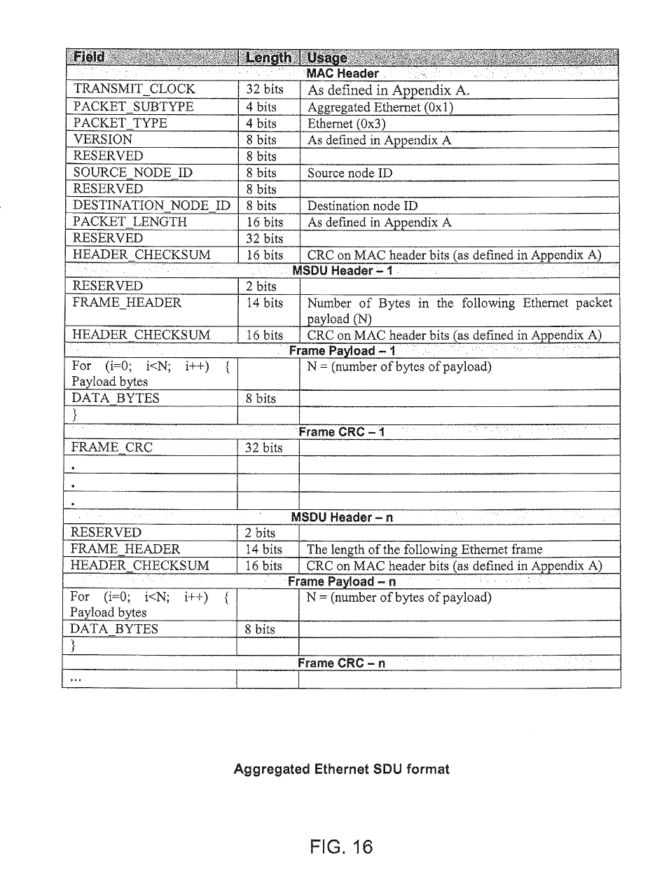

The Aggregated Ethernet format is depicted in the Table shown in FIG. 16.

It should be noted that the following described embodiment is one embodiment of a method according to the invention. The possibility of other methods according to the invention, or, alternatively, select portions of the following method, are within the scope of this disclosure.

For the purpose of the following description, a Transmitting Node (TN) is a node with pending aggregated packets that is requesting transmission opportunities for the transmission of the pending aggregated packets. A TN can either be an ordinary node or a NAC.

In a RR message, the TN may request a reservation for the Aggregation Frame (AF) in the manner described below. The way that the NAC handles its pending aggregated request may be implementation dependent.

The NAC may either, grant the permission to transmit the entire AF, grant a permission to transmit part of the AF, or distribute the transmission time for the AF over several time slots in the next MAP cycle, so that latency requirements are met and bandwidth is optimized for performance. Those skilled in the art will recognize that various algorithms are available to perform this optimization. Permission to transmit the ungranted packets may either be requested again by the transmitting node or the ungranted packets may be discarded by the TN.

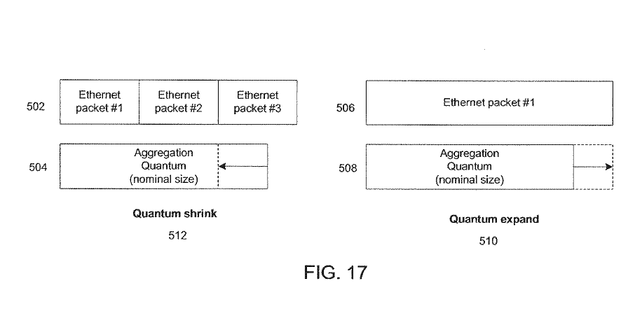

The aggregation method is based on an “Aggregation Quantum (AQ)”. An AF is composed of one or more AQ units which allow the NAC to break the AF into multiple transmission grants each containing an integer number of AQ units. Each AQ may be predefined to be a nominal size by software in terms of OFDM symbols. The actual size of an AQ is determined by the TN during the buildup of the AF as described below in the portion of the specification corresponding to FIG. 17.

AQs preferably map multiple complete Ethernet packets (i.e. typically Ethernet packets may not be fragmented).

FIG. 17 shows an illustration of actual vs. nominal quantum size. The nominal size of the AQs may be different, such as nominal sizes 504 and 508, for different proposed AFs 502 and 506 of Ethernet packets indicated by reference numerals 540a-540d, (referred to collectively hereinafter as “Ethernet packet(s) 540”). For example, the first AQ 504 may have a size that fits at least a burst size greater than two Ethernet packets 540, while following AQ 506 may be smaller than a single Ethernet packet 540. During AF build up, the AQ size may be expanded size 510 or reduced to size 512 to an integer number of Ethernet packets 540 as is shown in FIG. 17.

Prior to the aggregation build up, the number of data bytes in each AQ nominal size may be calculated, for example, according to a MoCA specification. This calculation depends on the number of bits per OFDM symbol (Nbas). It can be done a priori and may be updated when the Bit Loading profile is updated.

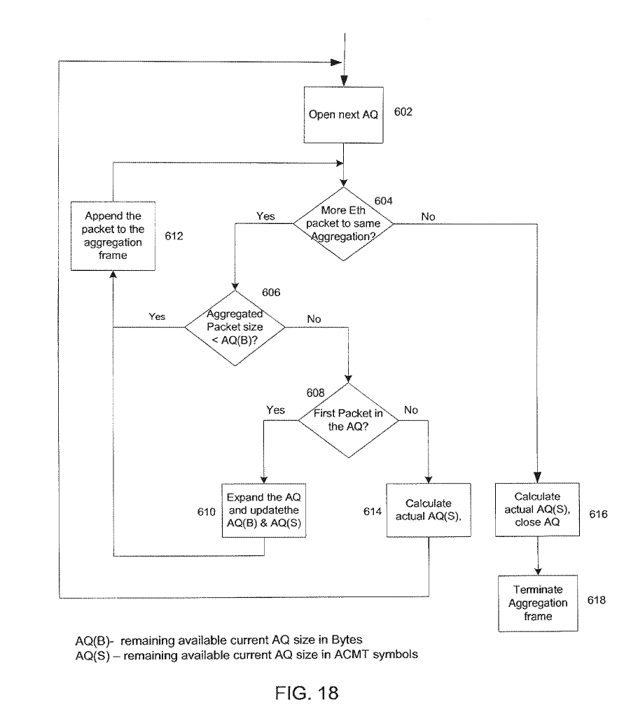

The AF build process is depicted in FIG. 18. More particularly, FIG. 18 is a flow chart for preparing an RR for to request permission to transmit an AF.

Step 602 shows the start of the aggregating a group of packets from an input queue into a AF that may have a size of a nominal AQ. Ethernet packets are added to the AF until there are no Ethernet packets remaining in the input queue as shown in step 604. If there Ethernet packets remains in the input queue and if the nominal size of an AQ is not exceed by adding next Ethernet packet to the AF, as shown in step 606, the TN may append the Ethernet packet to the AF as shown in step 612 and then return to step 604.

If the nominal size of an AQ is exceeded by adding next Ethernet packet to the AF, in step 606, a choice is made if Ethernet packet being added to the AF is the first Ethernet packet in the AF at step 608. If the Ethernet packet being added to the AF is the first Ethernet packet of the AF then the AQ is expanded at step 610, so that the AQ size in Bytes is the smallest multiplication of Nbas that is larger than the size of the first Ethernet packet. The TN may append the Ethernet packet to the AF as shown in step 612 and then return to step 604 and continue to consider adding additional Ethernet packets to the AF until the remaining bytes of the expanded AQ not large enough to accommodate the next aggregated packet. In certain embodiments of the invention, an AQ may be expanded only once.

If the Ethernet packet being added to the AF is the not the first Ethernet packet of the AF then AQ size is reduced so that the AQ size in Bytes is the smallest multiplication of Nbas (Number of Bytes per OFDM symbol) that is larger than the boundary of the last aggregated packet in step 614. Any next Ethernet packet may be placed in a new AQ which may be done at step 602.

If the input queue is found to be empty at step 604, then Step 616 may calculate the actual AQ(S) duration according to, for example, MAC Frame size rules found in some MoCA specifications. Following optional step 616 the AF may be terminated and the reservation request may be built in step 618 as described in more detail below.

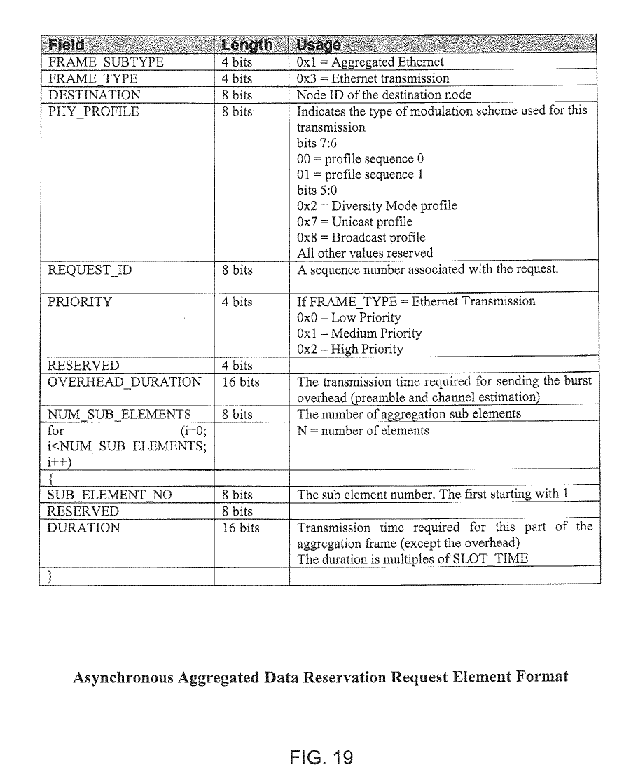

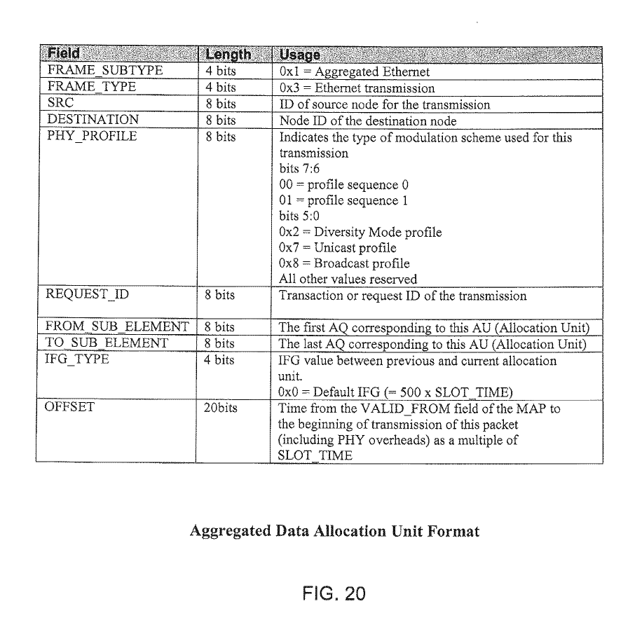

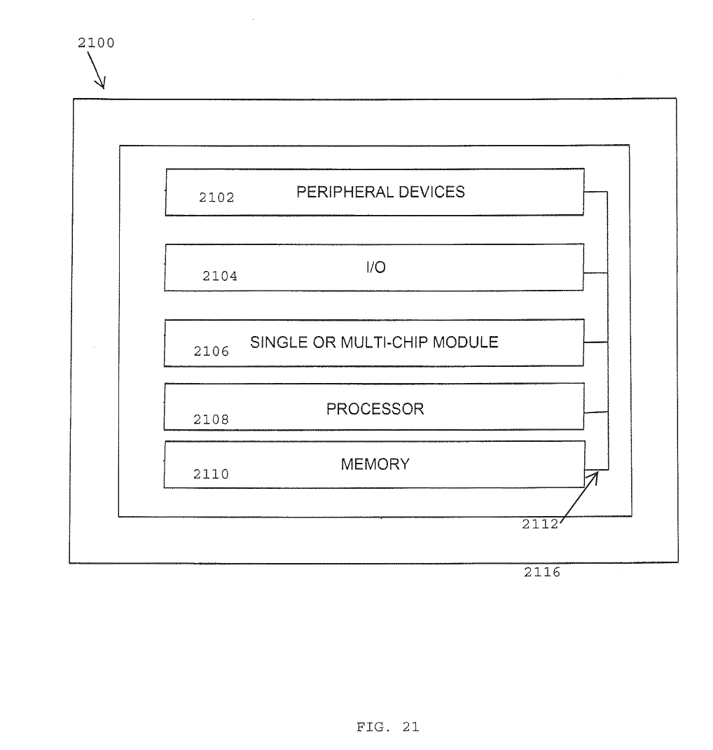

FIG. 19 shows a table illustrating an asynchronous aggregated data reservation request element format for use with systems and methods according to the invention. FIG. 20 shows a table illustrating an aggregated data allocation unit format.

Protocol details for processes according to the invention, and specifically the details that relate to the reservation request element for the aggregation frame, may be built from the RR element and sub elements describing the aggregation quanta. The RR element is numbered by REQUEST_ID as in, for example, the current MoCA specification, and the aggregation sub elements may be numbered by SUB_ELEMENT_NO starting at 1 for the first aggregation sub element.

The NAC in the Data Allocation Unit (DAU) response, for example, may copy the REQUEST_ID of the corresponding RR, and may add the FROM_SUB_ELEMENT and TO_SUB_ELEMENT fields according to the mapping of the aggregation frame into the DAU.

The transmitting node may fill in the OVERHEAD_DURATION field in its RR element including the duration of the Preamble corresponding to the aggregated frame transmission. The DURATION field in the sub element is filled with the transmission time of the data symbols calculated according to some MoCA specifications (note that this original calculation may preferably not include the aggregation preamble).

The NAC can calculate the aggregation frame duration by accumulating the DURATION time of all sub elements and the addition of the corresponding OVERHEAD_DURATION.

The Receiver node may de-aggregate the frame by de-capsulating the MAC header and MSDU headers. The MAC header indicates that the frame is a MoCA aggregated frame and may also indicate the total size of the aggregated frame. The subsequent MSDU headers may indicate the size of the encapsulated Eth packets. The MSDU header and the payload may be protected by a CRC.

Accordingly, if a MSDU header's CRC is invalid, the node may stop the de-aggregation and drop the remaining MSDUs in the frame.

If a payload's CRC is invalid, the node may drop some of the packets within the payload and continue to de-aggregate the next MSDU if any.

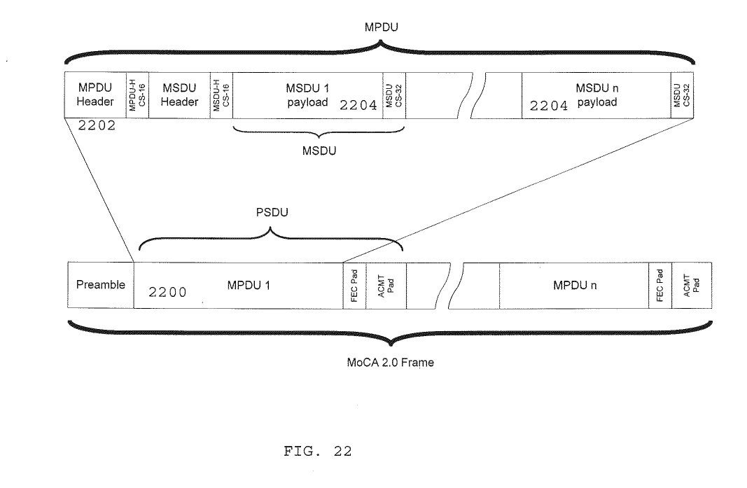

FIG. 21 shows a single or multi-chip module 2106 according to the invention, which can be one or more integrated circuits, in an illustrative data processing system 2100 according to the invention. Data processing system 2100 may include one or more of the following components: peripheral devices 2102, I/O circuitry 2104, processor 2108 and memory 2110. These components may be coupled together by a system bus or other interconnections 2112 and are disposed on a circuit board 2116 in an end-user system that may be in communication with a coax medium via an interface.

A MoCA 2.0 Frame is a frame that includes at least a Preamble and one or multiple OFDM symbols. MoCA2.0 frames may be separated by interframe gaps (IFG). A MoCA 2.0 frame may include one or more PSDUs (Physical Service Data Units) with identical or different MSDU priority levels. A PSDU is a data service unit that may include one or more OFDM symbols that integrate a single MPDU.

Some embodiments of the invention may include an enhanced aggregation mode. The enhanced aggregation mode may provide two or more levels of aggregation that are consistent with MoCA 2.0: MSDU aggregation and MPDU (MAC Protocol Data Unit) aggregation.

MSDUs of the same MoCA Flow may be aggregated into a single MPDU. There may be one or more MSDUs in an MPDU. In some embodiments, each of the MSDUs aggregated in an MPDU must have the same priority level. Each MSDU in the MPDU may be padded by a 4 byte Check Sequence.

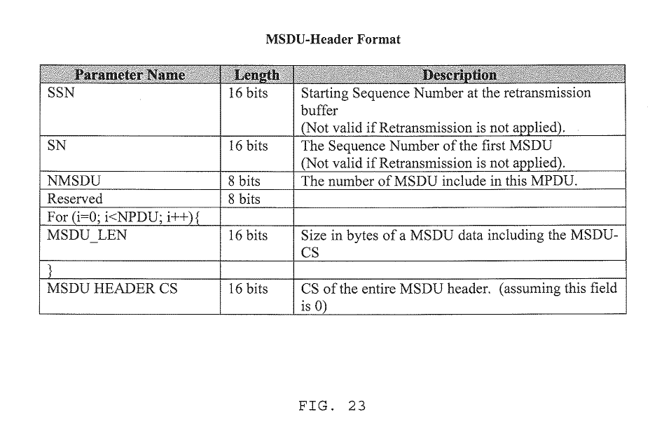

One MPDU may be integrated into one PSDU. One or more PSDUs may be aggregated to create a MoCA 2.0 Frame. FIG. 22 shows MPDU 2200 that includes MPDU header 2202 and one or more MSDUs 2204.

Each MPDU has its own MPDU header followed by the payload and the Check Sequence.

The MPDU is encapsulated in a PSDU. The PSDU may be defined by a number of symbols and/or a number of FEC codes, and may include FEC pads and/or OFDM pads. In some embodiments, the first byte of the MPDU must be aligned to the first PSDU symbol.

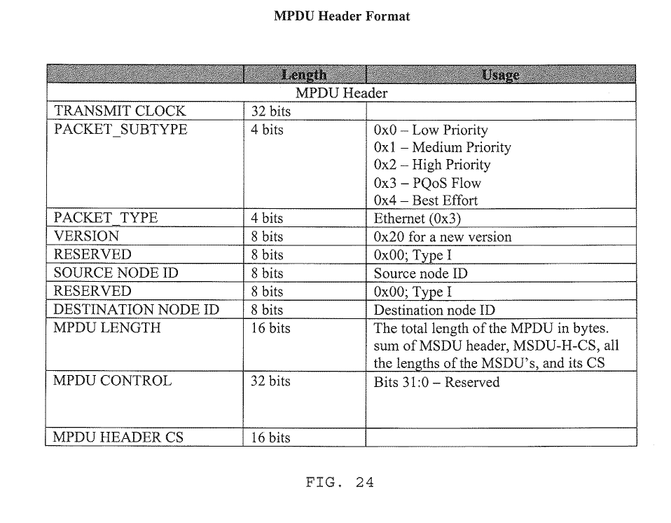

FIG. 23 shows an illustrative MSDU header format. The header of the MSDU may include retransmission information and the length of each MSDU. In some embodiments, if retransmission is not used for that aggregation of MSDUs, the retransmission fields are not valid.

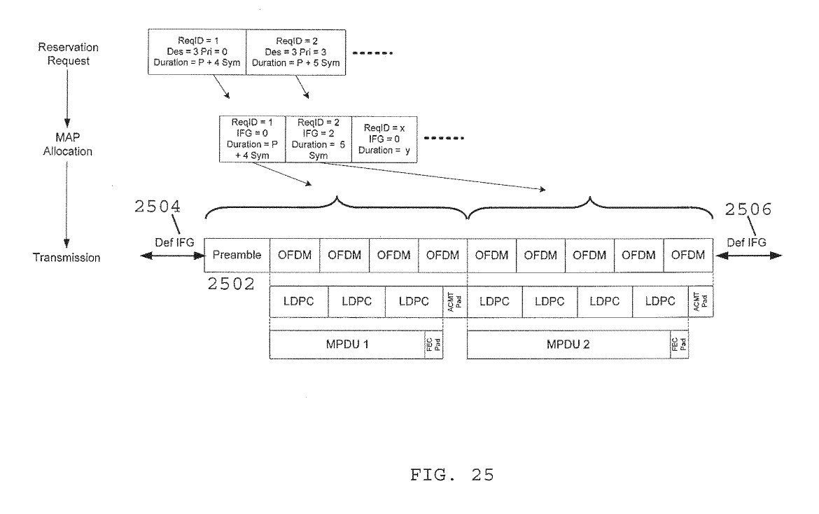

FIG. 24 shows an illustrative MPDU header format. The field of MPDU CONTROL in the MPDU header indicates the priority of the MSDU's (bits 3:0).

FIG. 25 shows that MPDU aggregation may aggregate two or more MPDUs, such as MPDU 1 and MPDU 2 in one MoCA 2.0 frame for sharing preamble 2502 and IFGs 2504 and 2506. The MPDUs may combine:
data with different priority levels,
control and data,
legacy and the most current version of MoCA 2.0 Specification, which is incorporated by reference herein in its entirety, MAPs.

Bandwidth reservation may be individually requested for each data priority and for control. The NC may then make aggregation decisions based on the bandwidth availability.

Each aggregated MPDU may have its own AU (Allocation Unit) in the MAP. The AU includes the FRAME_SUB/TYPE and the DURATION. The DURATION of the first AU in the MoCA 2.0 frame is the sum of the preamble duration and the number of symbols of the first PSDU. The DURATION of the subsequent AUs includes only the number of OFDM symbols in each associated PSDU. The IFG of all the AUs but the first one are set to “no IFG (0x2)” to indicate that these AUs are aggregated to the first AU.

The NC keeps the node's profile to derive the preamble time from the total duration.

In some embodiments, legacy MoCA MAPs and MoCA 2.0 MAPs may be aggregated.

In mixed mode, network legacy MAP and MoCA 2.0 MAP could be sent in separate MPDUs and share the same preamble. In some embodiments, the MoCA MAP must always be the first aggregated MAP. In some embodiments, this MAP may be parsed only by MoCA nodes. In some embodiments, the MOCA 2.0 MAP must be concatenated to the MoCA MAP and is ignored by the MoCA nodes. In some embodiments, the two MAPs must have the same VALID FROM and VALID_TO times. In some embodiments, the duration of the MoCA traffic must be covered with a TAU in the MoCA MAP.

Frame Fragmentation

Aggregation is required to increase the effectiveness of the MAC throughout MoCA 2.0, the next generation of the MoCA specification following the aforementioned MoCA specification. Therefore, aggregation of up to 16 KB is specified under some MoCA specifications.

Such aggregation may generate long MoCA frames. As an example—a single frame of 16 KB may be as long as 32 OFDM symbols when using maximal bit loading, or almost 200 uSec long.

These long frames may sometimes limit the available throughput because of such long time slots may not typically be available in a MAP. A MoCA 2.0 embodiment of systems and methods according to the invention may use a “breathing” MAP cycle that may adapt its size, and/or specifications, so that the breathing MAP cycle can accommodate long MoCA frames, thereby significantly mitigating the above-described limitation. Nevertheless, some specific applications may require fragmentation of a single long MoCA frame into two or more shorter frames.

For the applications in which fragmentation is required, the following specifications provide a fragmentation method according to the invention that ensures that all fragmented frames are comprised of complete non-fragmented MSDUs. This method avoids the need to support de-fragmentation in the receiver, and, accordingly, may significantly reduce the required complexity of the receiving node.

The NC decides whether to fragment an MPDU when scheduling time allocations for the next MAP cycle. The NC has the ability to calculate the DURATION of the fragmented frames, and to allocate transmission opportunities accordingly, by indicating to the requesting node that the requesting node needs to fragment its requested frame, and, to indicate to the requesting node how the fragmentation should be done. The ingress node then prepares each frame according to the time allocated by the NC.

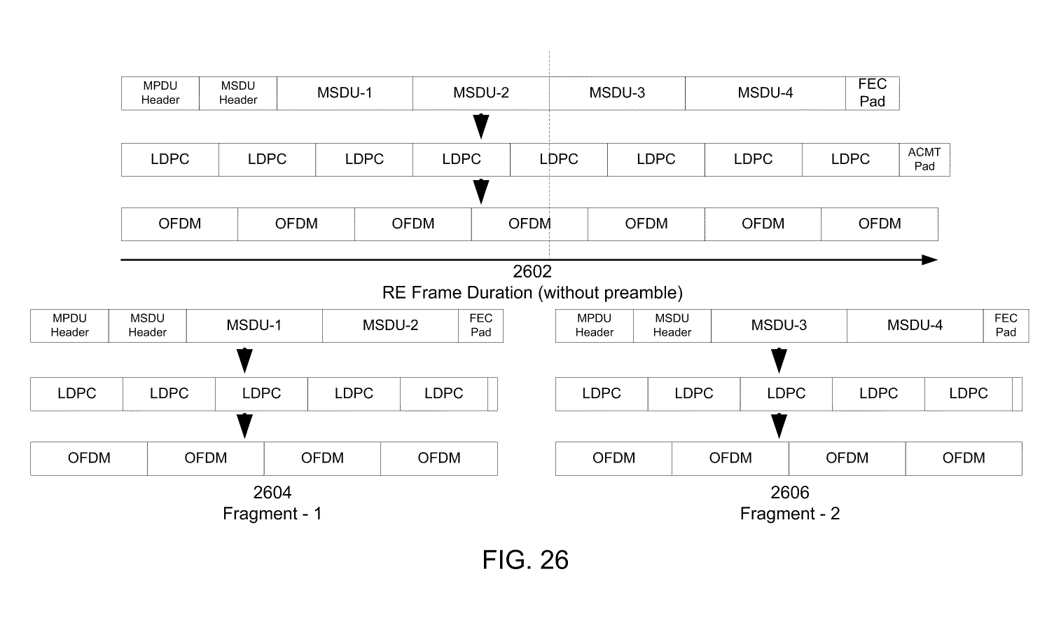

FIG. 26 illustrates how a single aggregated MPDU 2602 can be fragmented into two MPDUs 2604 and 2606 according to the invention; each transmitted in a different MoCA frame. Each fragment 2602, 2604 preferably includes its own MPDU header and MSDU header followed by an integer number of MSDUs with minimal FEC padding.

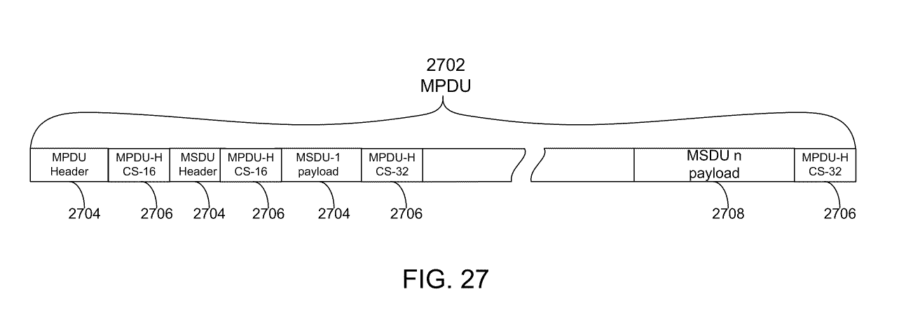

FIG. 27 shows an illustrative MPDU aggregation format 2702 according to the invention. Format 2702 preferably includes MPDU Headers 2704, Check sums2706 and payload(s) 2708.

An illustrative MSDU header format is shown in the following table:

| Parameter | | |
|---|---|---|
| Name | Length | Description |
| SSN | 16 bits | Starting Sequence Number at the |
| | | retransmission buffer |
| | | (Not valid if Retransmission is not applied). |
| SN | 16 bits | The Sequence Number of the first MSDU |
| | | (Not valid if Retransmission is not applied). |
| NMSDU | 8 bits | The number of MSDU include in this MPDU. |
| Reserved | 8 bits | |
| For (i=0; | | |
| i<NPDU; | | |
| i++){ | | |
| MSDU_LEN | 16 bits | Size in bytes of a MSDU data including the |
| | | MSDU-CS |

NC Operation

Upon receiving requests for bandwidth reservations, the NC preferably optimally fits the requests to the MAP cycle. The NC may decide to divide a single reservation request into multiple DAUs by fragmenting the original requests.

The NC should schedule the duration of the fragmented frames according to the current transmitter profile. The NC preferably keeps the profile parameters of all transmission nodes to be able to calculate the duration required by any frame transmission.

If the NC does not grant all the fragments within the next MAP cycle, the NC could either:

1) allocate a new RR to the transmitter to let the transmitter request new bandwidth reservation for its un-granted packets, in which case the NC flushes the un-granted request; or

2) does not allocate RR and grant transmission for the outstanding fragments in the subsequent MAP cycles.

AUs of fragments associated with the same request should preferably be allocated with the same REQUEST_ID and the same profile sequence that the original request.

Fragmentation according to the invention may be done along the lines of packet boundaries. The NC is preferably aware the size of the packets for which bandwidth is requested. The NC may select the maximum time interval which could be allocated to a specific request and grants packets within this interval until the remaining time is not large enough to fit the next (whole) packet. The resulting allocation time is shorter or at least equal to the maximum time interval.

In order to keep the order of packets and to avoid reordering at the receiver, the NC should preferably not schedule any other data transmission of the same MoCA Flow between the transmission intervals of the fragmented bursts.

Transmitter Operation

A MoCA 2.0 transmitter aggregates data MSDUs with the same MoCA Flow to request the duration needed for that transmission. When fragmentation is required the transmitter may append to a Reservation Request Element (“RE”) a list of all the MSDUs corresponding to the RE and their length in units of 8-Bytes.

The Reservation Request Element for the MoCA 2.0 format is defined in the Table below.

The last indication bit set in a DAU indicates to the transmitter that all the bandwidth allocation associated with a specific REQUEST_ID have been granted.

Reservation Elements format when Fragmentation According to the invention is applied:

Reservation requests are sent by a requesting node to the NC to reserve bandwidth for transmission of data or control already received from the ECL.

The format of this request is described in the table below.

| Field | Length | Usage |
|---|---|---|
| FRAME_SUBTYPE | 4 bits | 0x0 = ETHERNET_PACKET |
| FRAME_TYPE | 4 bits | 0x3 = Ethernet Transmission |
| Destination | 8 bits | Node ID of the destination node |
| PHY_Profile | 8 bits | Indicates the type of modulation scheme |
| | | used for this transmission |
| | | bits 7:6 |
| | | 00 = profile sequence 0 |
| | | 01 = profile sequence 1 |
| | | bits 5:0 |
| | | 0x2 = Diversity Mode profile |
| | | 0x7 = Unicast profile |
| | | 0xD = Unicast profile in MoCA 2.0 |
| | | PHY |
| | | All other values reserved. |
| Request_ID | 8 bits | A sequence number associated with the |
| | | request. |
| total_size | 12 bits | Total data size of the FEC padding bits |
| | | in the last symbol. Combined with the |
| | | DURATION field, this field is used to |
| | | calculate the total MPDU size which |
| | | cannot exceed Sₐ, by NC. |
| PRIORITY | 4 bits | If FRAME_TYPE = Control |
| | | 0x0 |
| | | If FRAME_TYPE = Ethernet |
| | | Transmission |
| | | 0x0 - Low Priority |
| | | 0x1 - Medium Priority |
| | | 0x2 - High Priority |
| | | 0x3 - PQoS Priority |
| | | 0x4 - Higher Priority |
| DURATION | 16 bits | Transmission time required in multiples |
| | | of SLOT_TIME for transmission of the |
| | | MPDU of the A-PDU without |
| | | fragmentation |
| NUM_PACKETS | 8 bits | the number of packets includes in that |
| | | Reservation Request |
| For i=0, | | |
| i<NUM_ELEMENT | | |
| S, i++{ | | |
| SIZE | 8 bits | the packet size multiple of 8 bytes |
| } | | |

For the sake of clarity, the foregoing description, including specific examples of parameter values provided, is sometimes specific to certain protocols such as those identified with the name MoCA™ and/or Ethernet protocols. However, this is not intended to be limiting and the invention may be suitably generalized to other protocols and/or other packet protocols. The use of terms that may be specific to a particular protocol such as that identified by the name MoCA™ or Ethernet to describe a particular feature or embodiment is not intended to limit the scope of that feature or embodiment to that protocol specifically; instead the terms are used generally and are each intended to include parallel and similar terms defined under other protocols.

It is appreciated that software components of the present invention including programs and data may, if desired, be implemented in ROM (read only memory) form including CD-ROMs, EPROMs and EEPROMs, or may be stored in any other suitable computer-readable medium such as but not limited to disks of various kinds, cards of various kinds and RAMs. Components described herein as software may, alternatively, be implemented wholly or partly in hardware, if desired, using conventional techniques.

Features of the present invention which are described in the context of separate embodiments may also be provided in combination in a single embodiment. Conversely, features of the invention which are described for brevity in the context of a single embodiment may be provided separately or in any suitable subcombination.

What is claimed is:

1. A method of aggregating Ethernet frames in a node on a network comprising:
collecting at least one Ethernet frame;
requesting a transmission opportunity;
receiving a permission to transmit a portion of an aggregation frame;
aggregating at least one Ethernet frame into an Ethernet aggregation frame; and
transmitting an Ethernet aggregation frame.

2. The method of claim 1 further comprising implementing the aggregating in a Ethernet Convergence Layer.

3. The method of claim 1 further comprising implementing the aggregating in a Media Access Control Layer.

4. The method of claim 1 wherein the collecting includes collecting Ethernet packets that have the same destination.

5. The method of claim 1 wherein the receiving includes receiving the permission for an interval shorter than the entire aggregation request.

6. The method of claim 5 wherein the aggregation aggregates the number of Ethernet packets that will fit the received permission.

7. The method of claim 1 wherein the receiving includes receiving the permission for several intervals.

8. The method of claim 1 wherein the collecting includes collecting Ethernet packets that have the same priority.

9. The method of claim 1 wherein the aggregation includes encapsulating the aggregated Ethernet packets into an Ethernet convergence layer frame.

10. A method of aggregating Media Access Control (“MAC”) service data units in a node on a Multimedia over Coax Alliance (MoCA) network comprising:
collecting at least one MAC service data unit;
requesting a transmission opportunity;
receiving permission to transmit at least a portion of an aggregation frame;
aggregating at least one MAC service data unit into a Media Over Cable aggregation frame; and
transmitting an Ethernet aggregation frame.

11. The method of claim 10 wherein the collecting includes collecting MAC service data unit that have the same destination node ID.

12. The method of claim 10 wherein the collecting includes collecting MAC service data unit that have the same priority.

13. The method of claim 10 wherein the collecting includes collecting MAC service data unit that have the same source node ID.

14. The method of claim 10 wherein the requesting include request a permission for at least one MAC service data unit.

15. The method of claim 10 wherein the aggregation includes encapsulating the aggregated Ethernet packets into an Ethernet convergence layer frame.

16. The method of claim 10 wherein the requesting includes a list of MSDU in the request.

17. A method of fragmenting aggregation frames in a node on a network comprising:
receiving at least one aggregation request;
generating a permission for an integer number MSDU; and
transmitting the permission to transmit at least a portion of an aggregation frame.
